(19) United States
(12) Patent Application Publication
(10) Pub. No.: US 2007/0081939 A1
(43) Pub. Date: Apr. 12, 2007

(54) Solid fuel packaging system and method or hydrogen generation

(76) Inventors: Grant Berry, Hillsborough, NC (US); Ian Eason, Hillsborough, NJ (US); Keith A. Fennimore, Columbus, NJ (US); Leonard Hesse, Guilford, CT (US); Thomas G. Hesse, Guilford, CT (US); Richard M. Mohring, East Brunswick, NJ (US)

Correspondence Address: DICKSTEIN SHAPIRO LLP, 1825 EYE STREET NW, Washington, DC, 20006-5403, US

(21) Appl. No.: 11/243,963

(22) Filed: Oct. 6, 2005

(51) Int. Cl. C01B 3/08

(52) U.S. Cl. 423/657; 48/61; 206/.7; 420/900; 252/184

(57) ABSTRACT

A packaging system and method are disclosed for delivering a solid fuel component in pre-measured quantities for hydrogen generation. Each quantity may be contained in a sealed blister pack or in a plurality of blister packs connected in series for indexing through a solid fuel dispenser. The solid fuel may be a metal borohydride that is stored in its dry form and mixed with a liquid, as needed. The liquid may include water. The solid fuel component may be provided in various forms, including granules, pellets and powder.

### FIELD OF THE INVENTION

The present invention relates to the generation of hydrogen and, more particularly, to the generation of hydrogen from a fuel solution formed from solid and liquid fuel components.

### BACKGROUND OF THE INVENTION

Hydrogen is the fuel of choice for fuel cells. However, its widespread use is complicated by the difficulties in storing the gas. Many hydrogen carriers including hydrocarbons, metal hydrides, and chemical hydrides are being considered as hydrogen storage and supply systems. In each case, specific systems need to be developed to release the hydrogen from its carrier, either by reformation of hydrocarbons, desorption from metal hydrides, or catalyzed hydrolysis of chemical hydrides and water.

One of the more promising systems for hydrogen storage and generation utilizes borohydride salts as the storage media. The addition of water to borohydride salts produces hydrogen according the reaction shown in equation (1) below. The rate of reaction varies for the different borohydrides and, for some, the use of an acidic or metal catalyst to promote the reaction is preferred.
MBH₄+2 H₂O→MBO₂+4 H₂+heat (1)

Sodium borohydride (NaBH₄) is of particular interest because it can be dissolved in alkaline water solutions with virtually no reaction, in which case, the stabilized alkaline solution of sodium borohydride is referred to as fuel. The high pH stabilizes the solution so that no rapid hydrogen generation occurs until the fuel solution contacts a catalyst. Control of this contact allows the production of hydrogen on an “as-needed” basis.

Typical fuel solutions comprise from about 10% to about 35% by weight sodium borohydride and from about 0.01 to about 5% by weight sodium hydroxide as a stabilizer. These aqueous borohydride fuel solutions are non-volatile and do not burn, factors which impart handling and transport ease both in the bulk sense and within the hydrogen generator itself. The liquid fuel is stable at temperatures below 40° C., which is sufficient for those applications which consume fuel in an ongoing manner. However, hydrogen can evolve as the temperature increases, and the fuel solution may degrade on extended storage. This is problematic in certain applications such as standby power generators where the fuel is expected to be stored for a period of time without hydrogen generation or consumption. In such cases, the fuel needs to be available at or near full strength for months.

The effect of temperature on fuel stability also complicates shipment of fuel as a liquid solution. To compensate for non-optimum shipping conditions and transit delays, the fuel must be stable under a variety of extreme conditions. Further, transportation of large quantities of liquid fuel is impractical as this would entail the movement of large amounts of water and add to weight and cost.

### BRIEF SUMMARY OF THE INVENTION

The present invention provides a packaging system that delivers the solid fuel component in convenient packages to facilitate dispensing, storage, and handling, while providing a protective barrier against water and other contaminants. The present invention also provides an improved system for generating hydrogen from a fuel prepared from a solid metal hydride and a liquid fuel component.

One embodiment of the present invention provides a packaging system that rapidly delivers pre-measured quantities of a solid fuel for hydrogen generation in conveniently packaged dosages to facilitate dispensing, storage, and handling. The solid fuel is a metal borohydride that is stored in a dry form and mixed with a liquid, as needed. Preferably, the solid chemical hydride is a solid metal borohydride having the general formula M(BH₄)ₙ, where M is selected from the group consisting of alkali metal cations, alkaline earth metal cations, aluminum cation, zinc cation, and ammonium cation, and is preferably sodium, potassium, lithium, or calcium, and n is equal to the charge of the cation. The liquid may include water. The solid fuel component may be provided in various forms, including but not limited to, granules, pellets and powder, for example.

Another embodiment of the present invention provides a hydrogen generation system in which hydrogen is generated through the use of a fuel solution prepared by dispensing solid and liquid fuel components. Advantageously, this solution can be prepared on an “as-needed” basis, to obviate the need for storing large amounts of fuel solution. The present invention is not limited, however, to the generation of hydrogen on an “as-needed” basis. Predetermined amounts of the solid and liquid fuel components may be mixed within a chamber to form a fuel solution having a uniform concentration of the metal borohydride. Optionally, the fuel solution may be passed over a catalyst to accelerate the generation of hydrogen.

The invention also provides a method of generating hydrogen and controlling the hydrogen generation by (i) providing a solid fuel component in pre-packaged dosages; and (ii) providing a fuel solution by dispensing a liquid fuel component and the solid from the pre-packaged dosages to generate hydrogen.

The accompanying drawings together with the detailed description herein illustrate these and other embodiments and serve to explain the principles of the invention. Other features and advantages of the present invention will also become apparent from the following description of the invention which refers to the accompanying drawings.

### BRIEF DESCRIPTION OF THE DRAWINGS

A complete understanding of the present invention may be obtained by reference to the accompanying drawings when considered in conjunction with the following detailed description, in which:

FIG. 1 is a schematic illustration of a solid fuel dispensing system in accordance with the present invention;

FIG. 2 is a schematic illustration of a hydrogen generator using a fuel dispensing system in accordance with the present invention;

FIG. 3 is a block diagram illustrating a method for generating hydrogen using a solid fuel dispensing system in accordance with the present invention; and

FIG. 4 is a schematic illustration of another hydrogen generator using a fuel dispensing system in accordance with the present invention.

### DETAILED DESCRIPTION OF THE INVENTION

A process for generating hydrogen from a stabilized metal hydride solution is described in commonly-assigned U.S. Pat. No. 6,534,033 entitled “System for Hydrogen Generation,” the disclosure of which is hereby incorporated by reference in its entirety.

The present invention provides a packaging system that delivers a solid fuel component in conveniently pre-packed dosages, to facilitate dispensing, storage and handling of such solid fuel component, while providing a protective barrier against water and other contaminants. The packaging system easily delivers pre-measured quantities of the solid fuel for hydrogen generation in conveniently packaged units. The solid fuel is a metal borohydride that is stored in a dry form and mixed with a liquid, as needed. The liquid may include water. The solid fuel component may be provided in various forms, including but not limited to, granules, pellets and powder, for example.

According to an exemplary embodiment of the present invention, a “daisy chain” packaging system provides a convenient fuel package that minimizes contact and exposure to the solid fuel component, and provides a means to readily deliver pre-measured quantities of the solid fuel component for conversion to a liquid fuel solution. The “daisy chain” packaging system also provides additional protection to the solid fuel from environmental elements such as water.

By “daisy chain” packaging system herein we mean a fuel supply comprising a series of individually packaged predetermined quantities of solid and/or liquid fuel components, each quantity enclosed within a sealed container and connected together. In an exemplary embodiment, each sealed container may be in the form of a blister pack, wherein the backing material (if one is used) to which the blister portion is sealed is continuous, so as to connect a series of individual blister packs in the form of a chain. Each blister pack may comprise, for example, a plastic, foil, shrinkwrap, or other suitable material sealed to a backing sheet or layer of, for example, plastic, cardboard, foil, or other suitable material, to form a sealed container to hold and protect the predetermined quantity of solid fuel or liquid until ready for use. Suitable sealed containers, blister packs, and daisy chains may be prepared by various methods of thermoforming, laminating, and molding as may be determined by one of ordinary skill in the art given the teachings herein. Alternatively, the packaging system of the present invention may employ individual, or a daisy chain of, dissolvable packs of, such as, cellulose, starch, polyvinyl alcohol (PVA), or polyurethane, for example to enclose and protect the fuel and/or liquid components. Such packs may be employed as fuel containers and may be connected to each other, with or without an additional backing material or film.

In an exemplary embodiment, the packaging system of the present invention comprises pockets, or blister packs, sealed to a film backing. The term “blister pack” encompasses any package holding a predetermined amount of solid or liquid fuel component, the package being sealed with a removable or tearable layer or film having at least a portion adapted to provide opening of the package, and optionally at least one perforated or tab portion for facilitating opening or indexing of the package. The blister or dissolvable packs of the present invention may be also provided in a side-by-side configuration, according to which one blister pack (or row of blister packs in a daisy chain) containing the solid fuel, for example, is disposed adjacent to a second blister pack (or row) containing the liquid fuel component. In this manner, the blister or dissolvable packs containing the solid fuel and the corresponding side-by-side or adjacent liquid fuel component may readily be dispensed into the mixing chamber at the same or about the same time.

The blister packs can be formed from various materials, for example, polymers and/or metal foils, chosen to produce a flexible blister or a rigid blister to suit the size and the needs of the specific application. The size of each individual blister or dissolvable pack can be varied to hold different amounts of the solid fuel. For example, a single blister may be packaged to allow ready mixing of a specific volume of a fuel solution of known concentration. The contents of one or more fuel packages may be added to a fuel cartridge for a hydrogen generating system, mixed with water, and the mixture agitated to produce a fuel solution. Representative examples of fuel cartridges are described in co-pending U.S. patent application Ser. No. 60/647392, entitled “Fuel Container for Hydrogen Generation System,” the disclosure of which is hereby incorporated by reference in its entirety.

In another exemplary embodiment, the packs may be dissolvable packs of, for example, cellulose, starch, polyvinyl alcohol (PVA), polyurethane, or other dissolvable material. The packs may be connected to each other or provided individually. The entire pack may be dropped into a cartridge and water may be added to dissolve the pack and make the fuel available. Such a system allows an individual to easily “re-fuel” a hydrogen generating system by adding a fuel package to a fuel cartridge, diluting with water, and agitating the mixture to produce the fuel solution. Alternatively, the fuel solution can be prepared in a separate container and poured into the fuel cartridge. Representative examples of fuel cartridges are described in co-pending U.S. patent application Ser. No. 60/647,392, entitled “Fuel Container for Hydrogen Generation System,” the disclosure of which is hereby incorporated by reference in its entirety.

The solid fuel component useful in an exemplary packaging and dispensing system of the present invention comprises a complex metal hydride that is water soluble and stable in aqueous solution, and that has the general formula M(BH₄)ₙ wherein M is a cation selected from the group consisting of alkali metal cations such as sodium, potassium or lithium, alkaline earth metal cations such as calcium, aluminum cation, and ammonium cation, and n is equal to the charge of the cation. Examples of suitable metal hydrides, without intended limitation, include NaBH₄, LiBH₄, KBH₄, and the like. These metal hydrides may be utilized in mixtures or individually. Preferred for such systems in accordance with the present invention are sodium borohydride (NaBH₄), lithium borohydride (LiBH₄), calcium borohydride (CaBH₄), and potassium borohydride (KBH₄), including mixtures thereof. Sodium borohydride is preferred for hydrogen generation due to its gravimetric hydrogen storage density of 10.9%, its multi-million pound commercial availability, and its relative stability in alkaline aqueous solutions.

The term “solid form” as used in the present application encompasses any substantially dry form, including powder, granules or pellets, for example.

The solid fuel component may optionally include a stabilizer that can raise the pH of the resultant fuel solution. Such stabilizers include metal hydroxides having the general formula M′(OH)_{n′}, wherein M′ is a cation selected from the group consisting of alkali metal cations such as sodium, potassium or lithium, alkaline earth metal cations such as calcium, aluminum cation, and ammonium cation, and n′ is equal to the charge of the cation. Examples of suitable metal hydroxides, without intended limitation, include NaOH, LiOH, NH₄OH, and the like. It is preferred that the cation portion of the alkaline stabilizing agent be the same as the cation of the metal hydride salt. For example, if the metal borohydride is sodium borohydride, the alkaline stabilizing agent would be sodium hydroxide, both of which are preferred in the practice of the present invention. Solid stabilized fuel compositions comprising borohydride and hydroxide salts are disclosed in co-pending U.S. patent application Ser. No. 11/068,838, entitled “Borohydride Fuel Composition and Methods” and filed on Mar. 1, 2005, the disclosure of which is hereby incorporated by reference in its entirety.

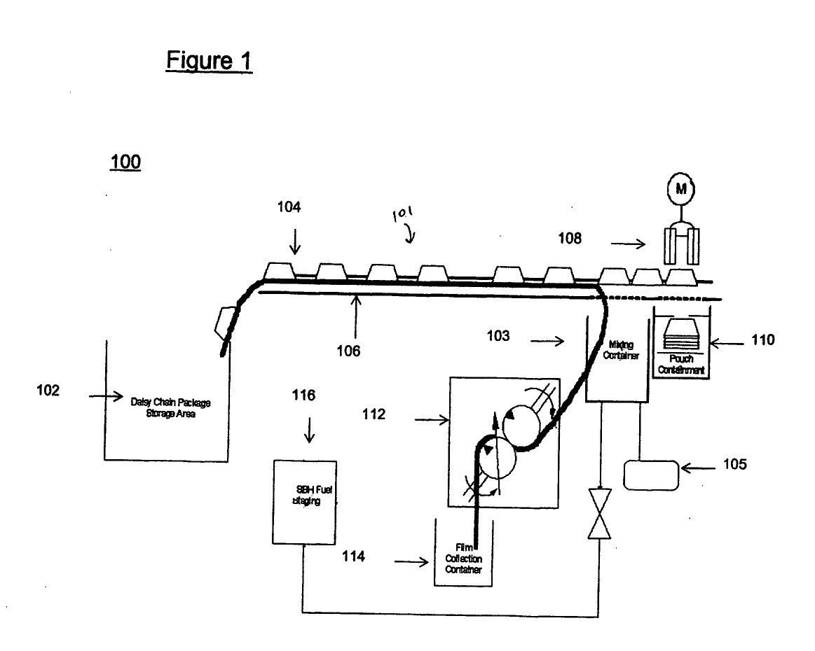

The use of the packaged solid fuel to prepare a fuel solution is not limited to portable fuel cartridges. The “daisy chain” packaging system of the present invention also provides a useful dispensing system to prepare larger quantities of a fuel solution when used in a fueling station. In such systems, it is desirable that the “daisy chain” have a peel tab or unsealed header so that the “daisy chain” can be inserted into a dispensing system as illustrated in FIG. 1 and the backing can be removed readily. Referring to FIG. 1, system 100 includes a “daisy chain” packaging system 101 comprising blister packs 104 and film backing 106, “daisy chain” storage area 102, stacker 108, pouch containment tank 110, mixing chamber 103, liquid fuel supply 105, spooling assembly 112, optional film container 114, and an optional fuel reservoir 116.

The film of the “daisy chain” packaging is fed though a spooling assembly 112, in which a motive force is applied to the packaging by a tensioning roller and roll drive, or a spool driven by a motor. As each blister pack approaches mixing chamber 103, the film is peeled from the blister pack to expose the contained solid fuel component, and the contained solid is delivered to chamber 103. The empty blister packs are collected by stacker 108 and stored in pouch containment tank 110. After passing though the spooling assembly, the film is collected in container 114. When the fueling station is refilled with a new “daisy chain,” the empty blister packs and corresponding used film can be removed from the system. The backing layer also may be coiled around the spool for storage, eliminating container 114. Alternatively, a mechanical means to remove the peel tab and open the blister pack may be provided. The mechanical means may be additionally employed to compress the empty blister pack in a waste compartment.

Liquid supply 105 is shown with a connection to a water line from a public water supply, private well or a filled water tank, for example. For temperatures below the freezing point of the water, an organic solvent such as ethylene glycol or methanol, can be added to the mixing tank to depress the freezing point of water, or the water in liquid supply 105 can be warmed. Alternatively, a stabilizer can be dissolved in, and dispensed with, the liquid fuel component. In a nonlimiting illustrative example, the delivery of about 20 g NaBH₄ and about 3 g NaOH from one or more blisters would require about 77 g of water from the liquid supply to produce about 100 g of a 20 wt-% NaBH₄ and 3 wt-% NaOH fuel solution.

Chamber 103 is preferably equipped with one or more switches to automate dispensing. For example, at least one level switch may be provided to monitor when the level of the mixed solution drops below a set point, and then to activate dispensing of at least one of the solid and liquid fuel components. The level switch can have another set point that shuts off the dispensing of the fuel components when the level of the solution in chamber 103 reaches a predetermined level. Various other means to monitor parameters such as solution level, hydrogen consumption or demand, and system pressure can likewise be employed to facilitate automatic dispensing.

To accelerate the mixing of the solid and liquid fuel components, chamber 103 is preferably equipped with a mixing means. Generally, any method of mixing can be used including, but not limited to, mechanical mixing devices such as tumblers, propellers, magnetic stirrers, or blenders, or physical mixing devices such as vibration mixers, sonicators, circulation pumps or air nozzles. Illustratively, the mixing mechanism can start before, at the same time, or after the solid and liquid fuel components are dispensed. The mixing mechanism may run continuously or intermittently.

An optional fuel reservoir 116 may be present in the system. In such a system, the fuel solution produced in mixing chamber 103 is transferred to the reservoir for storage. The advantage of this reservoir is that it allows multiple fuel batches and enables hot-swapping, i.e., loading of daisy chain or fuel supply while the unit is in operation (i.e., without a need to shut the system down before fueling). This reservoir may be bypassed if multiple fuel batches are not desired.

For rapid or “one-pot” hydrogen generation, a hydrogen generation catalyst may be packaged in a “daisy chain” or other package according to the present invention. For example, the hydrogen generation catalyst may be individually packaged in blister or dissolvable packs, as described above, or may be provided together with the solid fuel in the same pack. In the presence of water, the solid fuel reacts with the hydrogen generation catalyst to generate hydrogen. In this aspect, mixing chamber 103 may further include an outlet to deliver the gas for use by a power module comprising a fuel cell or hydrogen-burning engine for conversion to energy, or any other hydrogen device including balloons or hydrogen storage devices such as a hydrogen cylinder or metal hydride. Suitable solid catalysts include the chloride salts of manganese, iron, cobalt, nickel, and copper; transition metals, and boric acid.

The dispensing system 100 illustrated in FIG. 1 may be incorporated to construct an improved hydrogen generation system according to the present invention. Automated hydrogen generation systems which store the solid and liquid fuel components separately are described in U.S. patent application Ser. No. 10/115,269, entitled “Method and System for Generating Hydrogen by Dispensing Solid and Liquid Fuel Components,” filed Apr. 2, 2002, which is commonly assigned and the disclosure of which is hereby incorporated by reference in its entirety. In such a system, the solid fuel component is stored in bulk in a hopper or a container typically used for dispensing powders. While effective, this approach can require specific techniques to address the potential fine particles and dust control when re-filling the hopper.

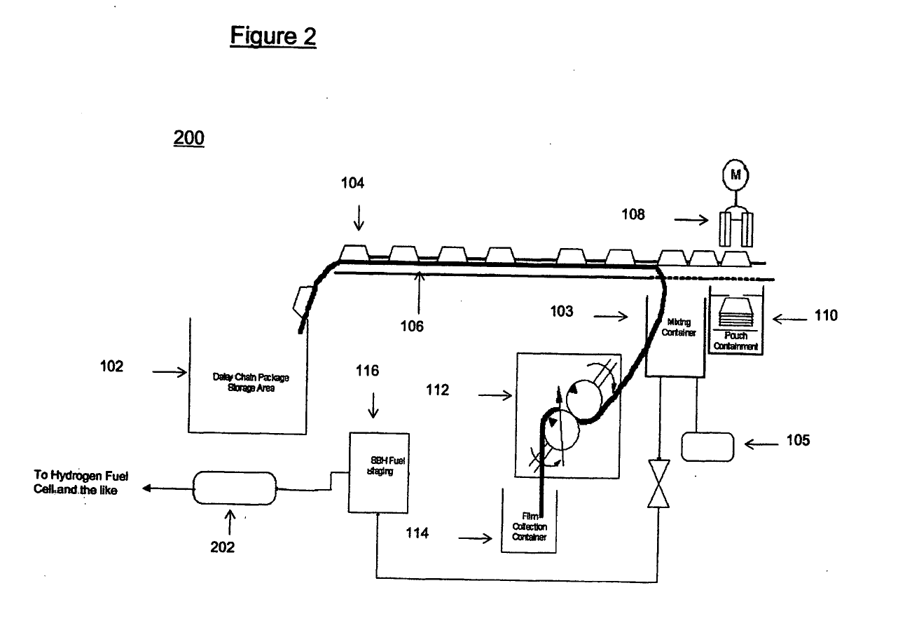

According to an exemplary embodiment of a hydrogen generation system that utilizes the fuel mixing station and “daisy chain” packaging of the present invention, the fuel solution reacts with a hydrogen generation catalyst. Such system is illustrated in FIG. 2, where features that are similar to those shown in FIG. 1 have like numbering. In such a system, the fuel solution produced in mixing chamber 103 can be transferred to the reservoir for storage prior to delivery to a reaction chamber 207. Alternatively, the fuel solution can be directly fed to reaction chamber 207 from the mixing chamber 103. The use of a reservoir allows multiple fuel batches to be prepared while the system is actively producing hydrogen and ensures that hydrogen production is essentially continuous.

To accelerate the hydrolysis reaction, reaction chamber 207 is preferably packed with a catalyst metal supported on a substrate. The preparation of such supported catalysts is taught, for example, in U.S. Pat. No. 6,534,033 entitled “System for Hydrogen Generation.” Suitable transition metal catalysts for the generation of hydrogen from a metal hydride solution include metals from Group IB to Group VIIIB of the Periodic Table, either utilized individually or in mixtures, or as compounds of these metals. Representative examples of these metals include, without intended limitation, transition metals represented by the copper group, zinc group, scandium group, titanium group, vanadium group, chromium group, manganese group, iron group, cobalt group and nickel group. Specific examples of useful catalyst metals include, without intended limitation, ruthenium, iron, cobalt, nickel, copper, manganese, rhodium, rhenium, platinum, palladium, and chromium, and mixtures thereof. Suitable carriers include (1) activated carbon, coke, or charcoal; (2) ceramics and refractory inorganic oxides such as titanium dioxide, zirconium oxide and cerium oxides; (3) metal foams, sintered metals and metal fibers or composite materials of nickel and titanium; and (4) perovskites with the general formula ABO₃, where A is a metallic atom with a valence of +2 and B is a metallic atom with a valence of +4. Structured catalyst supports such as honeycomb monoliths or metal foams may be used to obtain a desired plug flow pattern and mass transfer of the fuel to the catalyst surface.

In reaction chamber 107, the fuel solution undergoes the reaction of equation (1) to generate a product stream comprising hydrogen and a borate salt. The product stream can be directed to a gas liquid separator and the hydrogen gas processed through a heat exchanger to cool the gas stream. The conditioned hydrogen may be supplied to a device that consumes this gas, such as a hydrogen fuel cell or hydrogen-burning engine or turbine, or, alternatively, to one or more storage vessels. The borate product stream from the gas-liquid separator is typically drained to a borate storage tank.

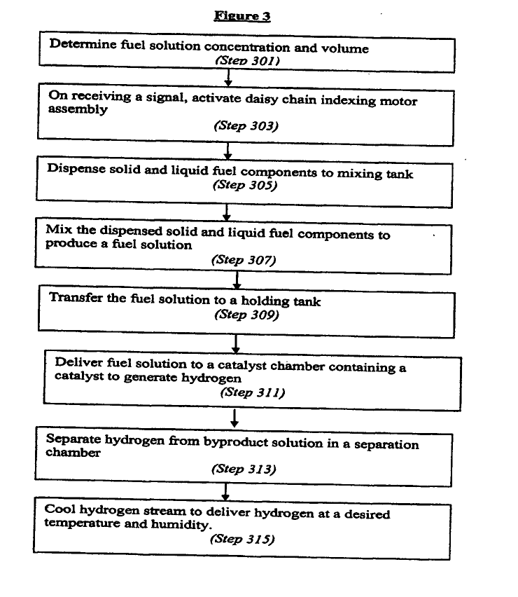

A method for generating hydrogen using a dispensing mechanism of the present invention is illustrated in FIG. 3. In an illustrative example, the solid fuel component is a mixture of sodium borohydride and sodium hydroxide packaged in a blister pack, and the liquid fuel component is water. In step 301, a fuel solution concentration and batch volume are determined relative to the operating demands of the system. At step 303, upon receiving a signal, the motor assembly for “daisy chain” indexing is activated. Such signals can include but are not limited to a manual switch, an indication of low solution volume in either chamber 103 or reservoir 116, loss of electrical grid power, or a need for hydrogen from a fuel cell. At step 305, predetermined volumes of water and solid fuel components to a mixing tank are dispensed into chamber 103. The dispensing of water and sodium borohydride can be started at the same time, or one after the other. At step 307, the dispensed sodium borohydride and water are preferably mixed to produce a homogeneous solution. At step 309, the fuel solution is transferred to fuel reservoir 216. Step 309 is optional and can be omitted. At step 311, the mixed solution is delivered to a reaction chamber containing a catalyst which activates the hydrolysis action of the mixed solution to generate hydrogen, steam, and discharged solution. At step 313, the hydrogen and steam are separated from the discharged solution in a separator. At step 315, the hydrogen and steam are cooled down at a heat exchanger, so that some steam is condensed, and the output hydrogen has a desired humidity. If humidity is not a concern, step 315 can be omitted.

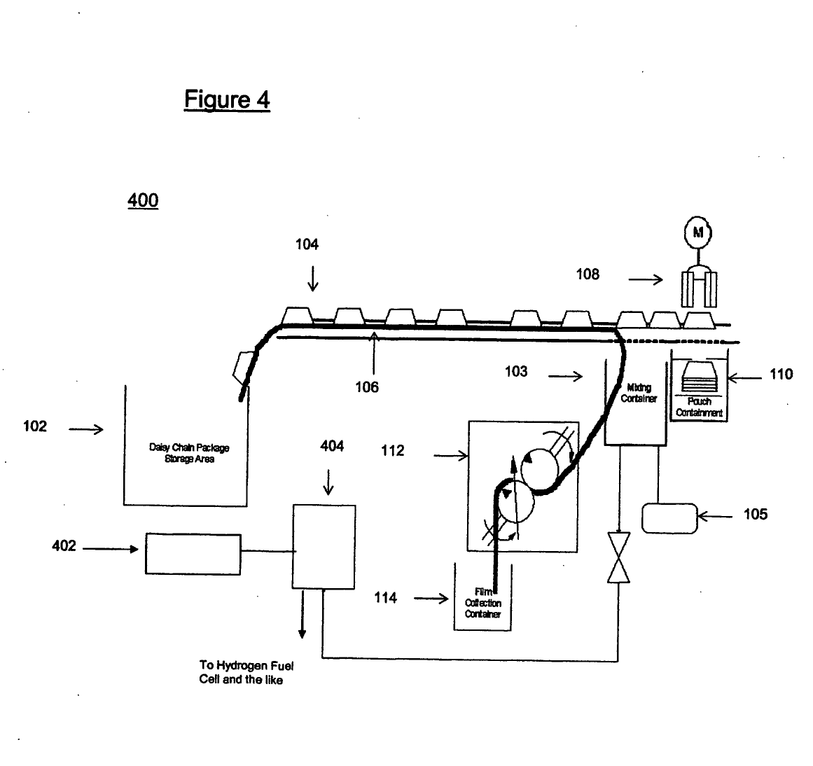

According to another embodiment of a hydrogen generation system that utilizes the fuel mixing station and “daisy chain” packaging of the present invention, the fuel solution is reacted with an acidic reagent solution to generate hydrogen. Such a system is illustrated in FIG. 4, where features that are similar to those shown in FIG. 1 have like numbering. The acidic reagent solution may comprise any suitable acid, including for example, inorganic acids such as hydrochloric acid (HCl), sulfuric acid (H₂SO₄), and phosphoric acid (H₃PO₄), and organic acids such as acetic acid (CH₃COOH), formic acid (HCOOH), maleic acid, citric acid, and tartaric acid, and water.

Hydrogen generation by the acid catalyzed hydrolysis of borohydrides occurs as shown in the following equations (2), (3) and (4) for a metal borohydride compound and hydrochloric acid:
MBH₄+6 H₂O −>MBO₂.4 H₂O+4 H₂ (2)
4 MBH₄+2 HCl+17 H₂O−>M₂B₇O₄.10 H₂O+16 H₂+2 MCl (3)
MBH₄+4 H₂O−>MBO₃. H₂O+3 H₂ (4)

In such a system, the fuel solution produced in mixing chamber 103 is transferred to a reaction chamber 404 which is connected to an acidic reagent supply 402. As hydrogen is needed, the acidic reagent is introduced into the reaction chamber to react with the fuel solution where the fuel solution undergoes reactions such as described by equations (2), (3) and (4) to generate hydrogen gas and a solution of borate salts.

The gas can be withdrawn from the reaction chamber through a suitable gas permeable membrane comprising silicon rubber, fluoropolymers or any hydrogen-permeable metal membranes such as palladium-gold alloys, that will allow hydrogen gas to pass through while maintaining solids and liquids within reaction chamber 404. Preferably, the hydrogen separation membrane is hydrophobic. The product stream can be processed through a heat exchanger to cool the gas stream. The hydrogen may be supplied to a device that consumes this gas, such as a hydrogen fuel cell or hydrogen-burning engine or turbine, or, alternatively, to one or more storage vessels. The discharged fuel solution comprising the borate salts may be drained to a borate storage tank.

The following examples further describe and demonstrate features of methods and systems for hydrogen generation and control according to the present invention. The examples are given solely for illustration purposes and are not to be construed as a limitation of the present invention. Various other approaches will be readily ascertainable to one skilled in the art given the teachings herein.

### EXAMPLE 1

A blister package according to the present invention was produced by forming a pocket from 6 mm thick food grade linear low density polyethylene (LLDPE) with dimensions of 80 mm×90 mm×40 mm, filling each pocket with about 150 g of a sodium borohydride/sodium hydroxide mixture (130.44 g of sodium borohydride and 19.56 g of sodium hydroxide) and sealing the pockets with 3 mm thick laminate of food grade linear low density polyethylene (LLDPE), aluminum, and polyethylene terephthalate (PET). The package further incorporated a 10 mm long peel tab to allow for easy opening of the pockets.

### EXAMPLE 2

The amount of solid fuel needed to be contained in each blister pack to produce a fuel solution of desired concentration is determined by considering factors such as fuel solution batch size, rate of hydrogen generation, fuel solution concentration, among others, to match the operational demands of the hydrogen generator. To prepare 100 g batches of a 20 wt-% NaBH₄ and 3 wt-% NaOH fuel solution, each blister pack in the “daisy chain” contains about 20 g of sodium borohydride and about 3 g of sodium hydroxide. Smaller blister packs allow flexibility in batch size. For example, 20 smaller blister packs, each containing about 1 g of sodium borohydride and about 0.15 g of sodium hydroxide, could be utilized to prepare the same 100 g batch of fuel solution. In both instances, a total of about 20 g NaBH₄ and about 3 g NaOH would be delivered. The smaller pack allows smaller batches to be prepared without waste. If only 50 g of fuel solution was necessary, only 10 of the small blister packs would need to be used.

The above description and drawings are only to be considered illustrative of exemplary embodiments, which achieve the features and advantages of the invention. Modification and substitutions to specific process conditions and structures can be made without departing from the spirit and scope of the invention. Accordingly, the invention is not to be considered as being limited by the foregoing description and drawings, but is only limited by the scope of the appended claims.

What is claimed as new and desired to be protected by Letters Patent of the United States is:

1. A fuel supply package comprising a sealed pack containing a solid fuel component, wherein the solid fuel component comprises a borohydride salt of formula M(BH₄)ₙ, wherein M is selected from the group consisting of alkali metal cations, alkaline earth metal cations, aluminum cation, zinc cation, and ammonium cation, and n corresponds to the charge of the selected M cation.

2. The package of claim 1, wherein the solid fuel component comprises about 20 to about 99.7% by weight of the borohydride salt.

3. The package of claim 1, wherein the solid fuel component further comprises a stabilizing amount of a hydroxide salt of formula M′(OH)_{n′}, wherein M′ is selected from the group consisting of alkali metal cations, alkaline earth metal cations, aluminum cation, zinc cation, and ammonium cation, and n′ corresponds to the charge of the selected M′ cation.

4. The package of claim 1, wherein the solid borohydride salt is selected from the group consisting of sodium borohydride, lithium borohydride, potassium borohydride, calcium borohydride, and mixtures thereof.

5. The package of claim 1, wherein the solid borohydride salt is selected from the group consisting of sodium borohydride dihydrate, potassium borohydride trihydrate, and potassium borohydride monohydrate, and mixtures thereof.

6. The package of claim 1, wherein the solid borohydride is sodium borohydride.

7. The package of claim 3, wherein the hydroxide salt is selected from the group consisting of sodium hydroxide, lithium hydroxide, potassium hydroxide, ammonium hydroxide, calcium hydroxide, and mixtures thereof.

8. The package of claim 1, further comprising a plurality of packs connected in a daisy chain configuration.

9. The package of claim 1, wherein the solid borohydride is in a form selected from the group consisting of granules, pellets or powder, or a combination thereof.

10. The package of claim 1, wherein the pack comprises a removable portion to allow access to the solid fuel component.

11. The package of claim 1, wherein the pack contains sodium borohydride and sodium hydroxide.

12. The package of claim 1, wherein the pack further contains a catalyst in contact with the solid fuel component.

13. The package of claim 12, wherein the catalyst comprises a material selected from the group consisting of transition metals and transition metal salts.

14. The package of claim 12, wherein the catalyst comprises a material selected from the group consisting of manganese (II) chloride, iron (II) chloride, cobalt (II) chloride, nickel (II) chloride, copper (II) chloride, boric acid, copper, zinc, scandium, titanium, vanadium, chromium, manganese, iron, cobalt, nickel, ruthenium, rhodium, rhenium, platinum, palladium, and mixtures thereof.

15. The package of claim 12, wherein the catalyst is in a form selected from the group consisting of beads, rings, pellets or chips, or a combination thereof.

16. The package of claim 1, wherein the pack is a blister pack.

17. The package of claim 1, wherein the pack is a dissolvable bag.

18. A fuel supply for generating hydrogen, comprising:
at least one disposable package containing a predetermined amount of a solid fuel component of formula M(BH4)ₙ, wherein M is selected from the group consisting of alkali metal cations, alkaline earth metal cations, aluminum cation, zinc cation, and ammonium cation, and n corresponds to the charge of the selected M cation; and
a liquid supply capable of providing a predetermined amount of a liquid component.

19. The fuel supply of claim 18, wherein the disposable package further comprises a stabilizing amount of a hydroxide salt of formula M′(OH)_{n′}, wherein M′ is selected from the group consisting of alkali metal cations, alkaline earth metal cations, aluminum cation, zinc cation, and ammonium cation, and n′ corresponds to the charge of the selected M′ cation

20. The fuel supply of claim 18, comprising a plurality of disposable packages connected in a daisy chain configuration.

21. The fuel supply of claim 18, wherein the solid fuel component is in the form of granules, pellets, powder, or a combination thereof.

22. The fuel supply of claim 18, wherein the liquid component is water.

23. An apparatus for hydrogen gas generation, comprising:
a fuel supply adapted to feed a plurality of sealed fuel packages connected in a daisy chain configuration, each package containing a solid fuel component;
a mixing chamber; and
a reaction chamber.

24. The hydrogen gas generation apparatus of claim 23, wherein the solid fuel component comprises
about 20 to about 99.7% by weight borohydride salt of formula M(BH₄)ₙ, wherein M is selected from the group consisting of alkali metal cations, alkaline earth metal cations, aluminum cation, zinc cation, and ammonium cation, and n corresponds to the charge of the selected M cation; and
a stabilizing amount of a hydroxide salt of formula M′(OH)_{n′}, wherein M′ is selected from the group consisting of alkali metal cations, alkaline earth metal cations, aluminum cation, zinc cation, and ammonium cation, and n′ corresponds to the charge of the selected M′ cation.

25. The hydrogen gas generation apparatus of claim 24, wherein the borohydride salt is selected from the group consisting of sodium borohydride, lithium borohydride, potassium borohydride, calcium borohydride, and mixtures thereof.

26. The hydrogen gas generation apparatus of claim 24, wherein the borohydride salt is selected from the group consisting of sodium borohydride dihydrate, potassium borohydride trihydrate, potassium borohydride monohydrate, and mixtures thereof.

27. The hydrogen gas generation apparatus of claim 24, wherein the hydroxide salt is selected from the group consisting of sodium hydroxide, lithium hydroxide, potassium hydroxide, ammonium hydroxide, calcium hydroxide, and mixtures thereof.

28. The hydrogen gas generation apparatus of claim 24, wherein the solid fuel component is in the form of granules, pellets, powder, or a combination thereof.

29. The hydrogen gas generation apparatus of claim 24, wherein the solid fuel component comprises sodium borohydride and sodium hydroxide.

30. The hydrogen gas generation apparatus of claim 24, wherein the fuel package is disposable.

31. The hydrogen gas generation apparatus of claim 24, further comprising a spooling assembly configured to feed the plurality of packages.

32. A method for preparing a fuel solution comprising:
providing a solid fuel supply in the form of a daisy chain of fuel packs, each pack containing a predetermined amount of solid fuel component;
at least a portion of each pack to deliver the predetermined amount of the solid fuel component to a mixing chamber; and
dispensing a liquid fuel component to the mixing chamber.

33. The method of claim 32, wherein providing the solid fuel component into a mixing chamber and dispensing the liquid fuel component into the mixing chamber are conducted simultaneously.

34. The method of claim 32, further comprising dissolving the solid fuel component to prepare the fuel solution.

35. The method of claim 32, further comprising removing at least a portion of each pack to expose at least a portion of the solid fuel component.

36. The method of claim 32, wherein each pack is in the form of a blister pack.

37. The method of claim 32, wherein each pack comprises a dissolvable material.

38. The method of claim 32, wherein the solid fuel component comprises:
about 20 to about 99.7% by weight borohydride salt of formula M(BH₄)ₙ, wherein M is selected from the group consisting of alkali metal cations, alkaline earth metal cations, aluminum cation, zinc cation, and ammonium cation, and n corresponds to the charge of the selected M cation; and
a stabilizing amount of a hydroxide salt of formula M′(OH)_{n′}, wherein M′ is selected from the group consisting of alkali metal cations, alkaline earth metal cations, aluminum cation, zinc cation, and ammonium cation, and n′ corresponds to the charge of the selected M′ cation.

39. The method of claim 32, wherein the solid fuel component is provided in a form selected from the group consisting of granules, pellets, powder, or a combination thereof.

40. A method of generating hydrogen gas, comprising:
providing a solid fuel component in a sealed fuel pack;
activating a motor assembly for fuel pack indexing; removing at least a portion of the seal from the fuel pack to deliver the solid fuel component to a mixing chamber;
dispensing a liquid fuel component to the mixing chamber;
dissolving the solid fuel component in the liquid to prepare an aqueous fuel solution; and
contacting the aqueous fuel solution with a reagent to produce hydrogen gas.

41. The method of claim 40, wherein the reagent comprises an acid selected from the group consisting of hydrochloric acid, sulfuric acid, phosphoric acid, acetic acid, formic acid, maleic acid, citric acid, and tartaric acid.

42. The method of claim 40, wherein the reagent comprises a catalyst.

43. The method of claim 42, wherein the catalyst comprises a transition metal.

44. The method of claim 42, wherein the catalyst comprises a material selected from the group consisting of copper, zinc, scandium, titanium, vanadium, chromium, manganese, iron, cobalt, nickel, ruthenium, rhodium, rhenium, platinum, palladium, and mixtures thereof.

45. The fuel supply of claim 42, wherein the catalyst is provided on a support in the form of a honeycomb monolith or a metal foam.

46. The method of claim 42, wherein the catalyst is provided on a support selected from the group consisting of activated carbon, coke, or charcoal.

47. The method of claim 42, wherein the catalyst is provided on a support selected from the group consisting of ceramics and refractory inorganic oxides.

48. The method of claim 42, wherein the catalyst is provided on a support that contains a metal in form of a foam, sintered particle, fiber, monolith, or a mixture thereof.

49. The method of claim 42, wherein the catalyst is provided on a support in the form of a perovskite of the formula ABO₃, where A is a metallic atom with a valence of +2 and B is a metallic atom with a valence of +4.

50. The method of claim 40, wherein the solid fuel component comprises:
about 20 to about 99.7% by weight borohydride salt of formula M(BH4)ₙ, wherein M is selected from the group consisting of alkali metal cations, alkaline earth metal cations, aluminum cation, zinc cation, and ammonium cation, and n corresponds to the charge of the selected M cation; and
a stabilizing amount of a hydroxide salt of formula M′(OH)_{n′}, wherein M′ is selected from the group consisting of alkali metal cations, alkaline earth metal cations, aluminum cation, zinc cation, and ammonium cation, and n′ corresponds to the charge of the selected M′ cation.

51. The method of claim 40, wherein the solid fuel component is in a form selected from the group consisting of granules, pellets, powder, or a combination thereof.

52. The method of claim 40, wherein the liquid fuel component is water.

53. The method of claim 40, wherein the fuel pack is disposable.

54. The method of claim 40, wherein each fuel pack comprises a predetermined amount of the solid fuel component.

55. The method of claim 40, further comprising providing a plurality of sealed fuel packs in a daisy chain configuration.

56. The method of claim 55, wherein each pack of the daisy chain is in the form of a sealed blister.

57. The method of claim 55, wherein at least one pack of the daisy chain is a dissolvable fuel pack.
